(19) United States
(12) Patent Application Publication
(10) Pub. No.: US 2010/0146506 A1
(43) Pub. Date: Jun. 10, 2010

(54) SYSTEM AND METHOD FOR OFFERING SYSTEM ON DEMAND (SoD) VIRTUAL-MACHINE

(75) Inventors: Hyungjik LEE, Daejeon-city (KR); Yunkyung PARK, Daejeon-city (KR); Jeunwoo LEE, Daejeon-city (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon-city (KR)

(21) Appl. No.: 12/607,260

(22) Filed: Oct. 28, 2009

(30) Foreign Application Priority Data
Dec. 8, 2008 (KR) 10-2008-0124225
May 29, 2009 (KR) 10-2009-0047763

(51) Int. Cl. G06F 9/455

(52) U.S. Cl. 718/1

(57) ABSTRACT

There are provided a system for offering a SoD virtual-machine includes a main server that includes: a server communication unit that transmits and receives data to and from a plurality of peripheral devices and a plurality of user terminals; a peripheral device detection unit that detects one or more peripheral devices among peripheral devices around the user terminal on the basis of user information received from the user terminal connected through the server communication unit and peripheral device information around the user terminal; and a server control unit that sets one or more peripheral devices detected by the peripheral device detection unit as IO devices of a virtual machine allocated to the connected user terminal.

### RELATED APPLICATIONS

The present application claims priority to Korean Patent Application Serial Number 10-2008-0124225, filed on Dec. 8, 2008 and Korean Patent Application Serial Number 10-2009-047763, filed on May 29, 2009, the entirety of which are hereby incorporated by reference.

### BACKGROUND OF THE INVENTION

1. Field of the Invention

The present invention relates to a system and a method for offering a system on demand (SoD) virtual-machine, and more particularly, to a system and a method for offering a SoD virtual-machine which provides a virtual machine using ubiquitous computing peripheral devices positioned around a user on a user's request as a resource.

2. Description of the Related Art

Computing architecture widely used in the related art, as a client/server system, software should be installed and executed for each of high-performance client computers installed under a known server and client network environment in order to use application software. In addition, a server just generally only serves to connect a client to a network or store shared files or programs.

A server-based computing technology in which most of the jobs are performed in a server computer has been developed. The server-based computing technology is also referred to as a thin-client computing environment. An example of the system may include a ‘terminal service’ of the MS Corporation. In the server-based computing, the application program is executed in the server and the application program installed in the server can be accessed regardless of a client peripheral device through a terminal emulator in the client.

Therefore, all jobs which the users perform in a terminal corresponding to the client are performed in the server and the job result is displayed on a screen of a user's job terminal. Since all jobs currently performed in a personal computer (PC) are actually performed in the server, the PC needs not to be provided with storage devices such as a hard disk, a floppy disk, etc. unlike the known PC, thereby reducing the price of the terminal of the client.

Further, the server-based computing technology provides an environment in which multiusers can independently execute different application programs by accessing one server.

The terminal service is mounted on a server system based on Windows NT/2000/Net server operating system (OS) of the MS corporation. An application program required for the server system is installed only once and the user executes an emulator which can access the terminal service in his/her own computer. The emulator executed in the user's computer accesses the server through the network to use the application program installed in the server system.

The virtual system includes a SoD virtual-machine offering system which creates a virtual machine by using a resource (or peripheral device) on the user's request and offers the virtual machine to the corresponding user. That is, the SoD virtual-machine offering system offers a virtual machine that is constituted by a resource (or peripheral device) that the user prefers.

The known SoD virtual-machine offering system creates the virtual machine by using a resource previously set by the user and offers the virtual machine to the corresponding user. That is, the known SoD virtual-machine offering system informs the user of a limited resource (or peripheral device), creates the virtual machine by using the resource selected by the user, and offers the virtual machine to the corresponding user.

However, in general, the known SoD virtual-machine offering system allows one user to use information of a plurality of virtual systems or allows a plurality of users to use a limited peripheral device that is connected to the system regardless of supporting the plurality of users. In particular, the user could not replace a predetermined peripheral device with a peripheral device that the user wants to use or prefers.

### SUMMARY OF THE INVENTION

The present invention is contrived to solve the above-mentioned problems. An object of the present invention is to provide a system and a method for offering a SoD virtual-machine, which can construct a computing environment suitable for a circumstance around a user by offering a virtual machine using a plurality of peripheral devices positioned around the user as input/output devices.

Another object of the present invention is to provide a method for managing a peripheral device which allows a system on demand virtual-machine offering system to recognize and use a ubiquitous computing peripheral device and a user authenticating device, a user interface having a function of arbitrarily changing the peripheral device when a user wants to change the peripheral device, and a method for managing a virtual system to be offered to the user.

In order to achieve the above-mentioned objects, the system for offering a SoD virtual-machine including a main server according to an embodiment of the present invention in which the main server includes: a server communication unit that transmits and receives data to and from a plurality of peripheral devices and a plurality of user terminals; a peripheral device detection unit that detects one or more peripheral devices among peripheral devices around the user terminal on the basis of user information received from the user terminal connected through the server communication unit and peripheral device information around the user terminal; and a server control unit that sets one or more peripheral devices detected by the peripheral device detection unit as IO devices of a virtual machine allocated to the connected user terminal.

The peripheral device detection unit detects one or more peripheral devices among the plurality of peripheral devices which can be connected through the server communication unit on the basis of user information including a usage history and a usage pattern of the virtual machine of the corresponding user.

The server control unit sets peripheral devices selected by the user terminal among one or more peripheral devices detected by the peripheral device detection unit as the IO devices of the virtual machine allocated to the corresponding user terminal.

The system for offering an SoD virtual-machine further includes a peripheral device management unit that creates and manages a list of peripheral devices on the basis of profile information received from the plurality of peripheral devices connected through the server communication unit.

The peripheral device management unit includes a peripheral device information storage module that stores the profile information of the plurality of peripheral devices and the list of the peripheral devices.

The peripheral device management unit sets a unique IP address and a unique connection port to the peripheral device connected through the server communication unit.

The peripheral device management unit creates connection information for connecting the peripheral devices through the server communication unit.

The system for offering an SoD virtual-machine further includes a user management unit that creates and manages the user information on the basis of user profile information received from the user terminal connected through the server communication unit.

The user management unit further includes a user information storage module that stores the user information and the user profile information and the user information storage module stores the user information including the usage history and the usage pattern of the virtual machine of the corresponding user and a preference.

In order to achieve the above-mentioned objects, a user terminal according to another embodiment of the present invention includes: a terminal storage unit that stores user profile information on a user of the user terminal; a terminal communication unit that transmits and receives data to and from the main server; a terminal management unit that manages peripheral device profile information on one or more peripheral devices around the user terminal connected through the terminal communication unit; and a terminal control unit that transmits the peripheral device profile information and the user profile information to the main server.

The terminal management unit creates connection information for connecting peripheral devices around the user terminal through the terminal communication unit.

In order to achieve the above-mentioned objects, a method for offering a SoD virtual-machine according to yet another embodiment of the present invention includes: allocating a virtual machine to a user terminal by a server control unit; receiving user profile information and profile information of peripheral devices around the user terminal from the user terminal by a server communication unit; detecting one or more peripheral devices, by a peripheral device detection unit, among a plurality of peripheral devices around the user terminal which can be connected through the server communication unit on the basis of the user profile information and the profile information of the peripheral devices around the user terminal; and setting detected one or more peripheral devices as IO devices of the virtual machine by the server control unit.

At detecting one or more peripheral devices, one or more peripheral devices are detected among the plurality of peripheral devices on the basis of a usage history and a usage pattern of the virtual machine of the corresponding user by the peripheral device detection unit.

At setting one or more peripheral devices detected by the server control unit as IO devices of the virtual machine, peripheral devices selected by the user terminal among detected one or more peripheral devices are set as IO devices of the allocated virtual machine by the server control unit.

The method for offering an SoD virtual-machine further includes creating and managing a list of peripheral devices on the basis of the profile information received from the plurality of peripheral devices by a peripheral device management unit.

At detecting one or more peripheral devices, a unique IP address and a unique connection port are set to the peripheral devices connected through the server communication unit by the peripheral device management unit.

At creating and managing the list of peripheral devices, connection information for connecting the peripheral devices is created through the server communication unit by the peripheral device management unit.

At creating and managing the list of peripheral devices, the information on the plurality of peripheral devices and the list of the peripheral devices are stored in a peripheral device information storage module by the peripheral device management unit.

The method for offering an SoD virtual-machine further includes creating and managing user information on the basis of the user profile information received from the user terminal by a user management unit.

At receiving user profile information and profile information of peripheral devices, the peripheral device profile information on one or more peripheral devices connected to the user terminal and the user profile information of the connected user terminal are received.

According to an embodiment of the present invention, a system and a method for offering a SoD virtual-machine can construct a computing environment suitable for a circumference status around a user by offering a virtual machine using a plurality of peripheral devices positioned around the user and a computing peripheral device as resources.

Further, the system and method for offering a system on demand virtual-machine can provide various input/output services by using formalized devices allocated to the virtual machine and a plurality of peripheral devices around the user as input/output devices.

That is, in the system and method for offering a system on demand virtual-machine, the user can arbitrarily use all ubiquitous computing peripheral devices distributed around the user, dynamically add a new peripheral device, and dynamically manage a virtual system environment.

### BRIEF DESCRIPTION OF THE DRAWINGS

FIG. 1 is a diagram illustrating an example in which a system and a method for offering a SoD virtual-machine are adopted according to an embodiment of the present invention;

FIG. 2 is a diagram illustrating a configuration of a system for offering a SoD virtual-machine according to an embodiment of the present invention;

FIG. 3 is a diagram for illustrating a configuration of a main server of FIG. 2;

FIG. 4 is a diagram for illustrating a configuration of a user terminal of FIG. 2;

FIGS. 5 and 6 are flowcharts for illustrating a method for offering a SoD virtual-machine according to an embodiment of the present invention; and

FIG. 7 is a flowchart for illustrating a method for registering peripheral devices according to an embodiment of the present invention.

### DETAILED DESCRIPTION OF THE PREFERRED EMBODIMENTS

Hereinafter, the most preferred embodiments of the present invention will be described with reference to the accompanying drawings for detailed description so that the spirit of the present invention can easily be performed by those skilled in the art. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention.

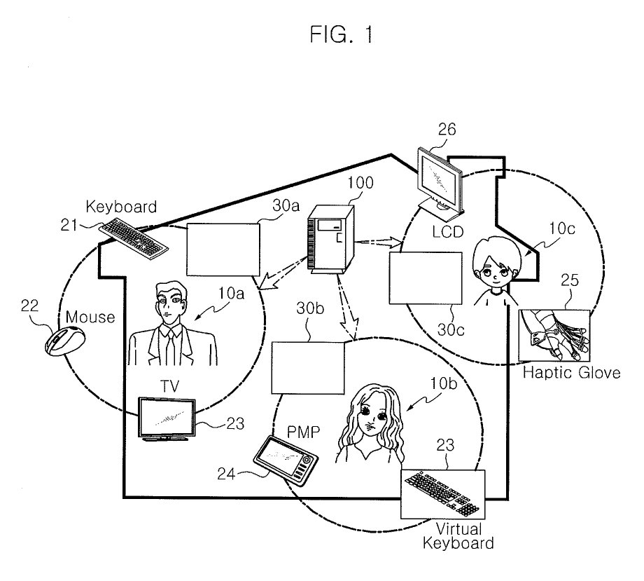

Before describing an embodiment of the present invention, an example in which a system and a method for offering a SoD virtual-machine are adopted according to an embodiment of the present invention will be described below with reference to the accompanying drawings. FIG. 1 is a diagram illustrating an example in which a system and a method for offering a SoD virtual-machine are adopted according to an embodiment of the present invention.

FIG. 1 illustrates a configuration diagram in which three users 10 perform works at the same time by using a virtual machine 30 that uses different peripheral devices 20 as input/output devices (i.e., keyboard video mouse (KVM)).

A virtual machine 30a of a first user 10a uses a general keyboard 21 and a general mouse 22 and a digital television 23 is constituted by a monitor. When the first user 10a performs a computing work while watching a television, the first user 10a may use the keyboard 21 and the mouse 22 included in his/her own virtual machine 30a. A virtual machine 30b of a second user 10b is constituted by a virtual keyboard 23 and a PMP 24. In this case, the PMP 24 is used as the monitor and the mouse. A third user 10c plays his/her favorite game in a room and a virtual machine 30c is constituted by a haptic equipment 25 and an LCD monitor 26. As shown in the example, a SoD virtual-machine offering system 100 that provides an SoD service, which is provided in the present invention allows a plurality of users 10 to perform their desired works at the same time by using their own virtual machines 30. The user 10 can arbitrarily replace the peripheral device 20 in use and does not need a work of any user 10 in order to configure a virtual computing environment.

(System on Demand Virtual-Machine Offering System)

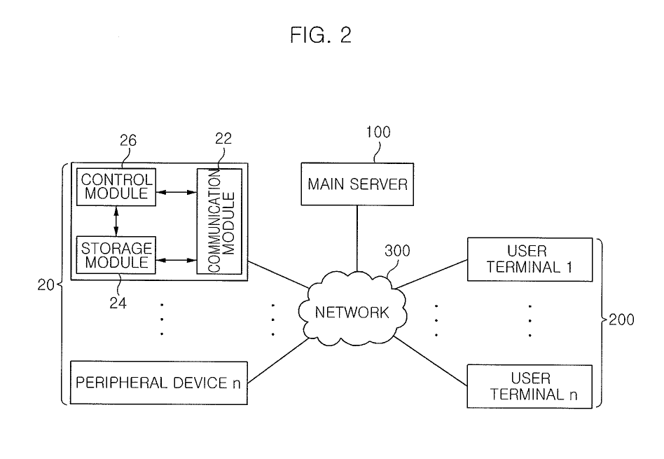

FIG. 2 is a diagram illustrating a configuration of a system for offering a SoD virtual-machine according to an embodiment of the present invention.

As shown in FIG. 2, the system on demand virtual-machine offering system includes a plurality of peripheral devices 20, a plurality of user terminals 200, and a main server 100. At this time, the plurality of peripheral devices 20, the plurality of user terminals 200 and the main server 100 transmit and receive data to each other through a network 300. Herein, the network 300 may use a wired network, but a wireless network is preferably used by considering mobility of the peripheral devices 20, the user terminals 200, etc. Of course, the wired network and the wireless network may be mixed and configured.

The plurality of peripheral devices 20 are installed in areas (for example, house, store, office, etc.) to which a system on demand virtual machine 30 is provided and are used as IO devices of the virtual machine 30 provided to a user. Each of the plurality of peripheral devices 20 incorporates a communication module 22 for data communication with the main server 100 to be described below. When each of the plurality of peripheral devices 20 is connected with the main server 100 to be described below, each peripheral device 20 transmits profile information of the peripheral device to the main server 100. At this time, each of the plurality of peripheral devices 20 incorporates the profile information of the peripheral device. That is, each peripheral device 20 incorporates the profile information of the peripheral device including device information (Device_Info), driver information (Driver_Info), resource information (Resource_Info), etc. Herein, the device information includes a peripheral device description (Device_Description), a peripheral device ID (Product_ID), a vendor ID (Vendor_ID), a peripheral device type (Device_Type), a peripheral device usage (Device_Usage), a peripheral device resolution (Device_Resolution), a connection interface (Connection_Interface), a button type (Button_Type), a color (Color), a key number (Key_Number), etc. The driver information includes a driver description (Driver_Description), a driver publisher (Driver_Publisher), a driver publisher URL (Driver_Publisher_URL), a driver date (Driver_Date), a driver version (Driver_Version), etc. The resource information includes a resource type (Resource_Type), a resource source (Resource Source), a resource authority (Resource_Authority), etc.

Herein, the plurality of peripheral devices 20 can use all devices in which the communication module 22 is incorporated in general devices such as a TV, a monitor, a PDA, an audio, a keyboard, a mouse, a printer, etc. to input or output data.

Herein, the peripheral devices 20 are discriminated from the user terminals 200 depending on whether or not user profile information is provided. That is, when profile information of the device user is included, the user terminal 200 is classified and when only profile information of the peripheral device is included, the peripheral device 20 is classified. At this time, the peripheral device 20 includes a communication module 22 that transmits and receives data with the main server 100 (or user terminal 200), a storage module 24 that stores the profile information of the peripheral device, and a control module 26 that controls to provide the profile information of the peripheral device on a request of the main server 100 (or user terminal 200).

The main server 100 creates and manages information on the plurality of peripheral devices 20 installed in the areas (for example, house, store, office, etc.) to which the SoD virtual machine 30 is provided. The main server 100 creates and manages information on the user who accesses the main server 100. The main server 100 detects one or more peripheral devices 20 to be used as the ID devices of the virtual machine 30 allocated to the user terminal 200 among the plurality of peripheral devices 20 on the basis of the user profile information and the peripheral device profile information that are received from the user terminal 200. The main server 100 allocates the virtual machine 30 that uses the one or more predetected peripheral devices 20 as the IO devices to the corresponding user terminal 200. Of course, the main server 100 may set one or more peripheral devices 20 selected by the user terminal 200 as the IO devices of the virtual machine 30. Herein, a detailed configuration of the main server 100 will be described below with reference to the accompanying drawings.

The plurality of user terminals 200 transmits the peripheral device profile information on the plurality of peripheral devices 20 positioned around the user and the user profile information to the main server 100. That is, each of the plurality of user terminals 200 incorporates the user profile information on the user of the user terminal 200 and when each user terminal 200 is connected to the main server 100, each user terminal 200 transmits the incorporated user profile information to the main server 100. At this time, each of the plurality of user terminals 200 includes the user profile information (that is, authentication information) for user authentication. Each of the plurality of user terminals 200 receives the peripheral device profile information from one or more peripheral devices 20 positioned around the user terminal 200 and transmits the received peripheral device profile information to the main server 100. Of course, each of the plurality of user terminals 200 may transmit profile information on devices which can be used as the IO devices in the terminal to the main server 100. For example, when the PMP is the user terminal 200, the PMP includes an LCD panel, a touch pad, etc and may transmit profile information of the LCD panel, the touch pad, etc. to the main server 100. Herein, a detailed configuration of the user terminal 200 will be described below with reference to the accompanying drawings.

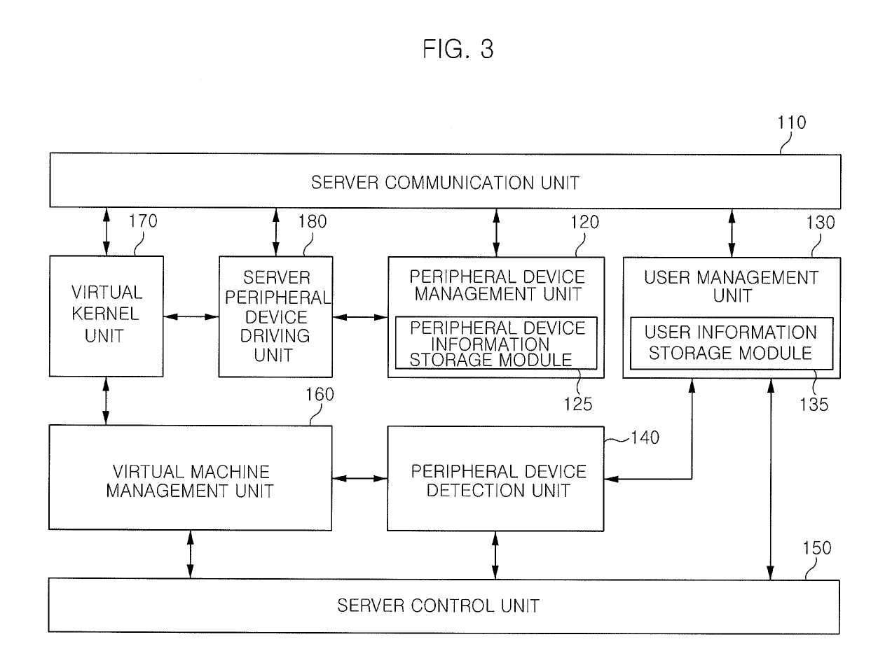

FIG. 3 is a diagram for illustrating a main server of FIG. 2.

As shown in FIG. 3, the main server 100 includes a server communication unit 110, a peripheral device management unit 120, a user management unit 130, a peripheral device detection unit 140, a server control unit 150, a virtual machine management unit 160, a virtual kernel unit 170, and a server peripheral device driving unit 180.

The server communication unit 110 transmits and receives data to and from the plurality of peripheral devices 20 and the plurality of user terminals 200. That is, the server communication unit 110 periodically transmits connection information for connecting the peripheral devices 20 on a request of the peripheral device management unit 120. The server communication unit 110 receives the peripheral device profile information from the plurality of peripheral devices 20 or the plurality of user terminals 200 and provides the received peripheral device profile information to the peripheral device management unit 120. The server communication unit 110 receives the user profile information from the plurality of user terminals 200 and provides the received user profile information to the user management unit 130.

The peripheral device management unit 120 manages information on the plurality of peripheral devices. That is, the peripheral device management unit 120 creates and manages a list of the peripheral devices on the basis of the peripheral device profile information received from the plurality of peripheral devices 20 connected through the server communication unit 110. Herein, the peripheral device management unit 120 serves to manage the plurality of peripheral devices 20 (for example, peripheral devices 20 used as the IO devices of the virtual machine 30 connected to the main server 100). The peripheral device management unit 120 manages a list of peripheral devices allocated the user when the virtual machine 30 is created or terminated and also manages a list of peripheral devices related to addition of a new peripheral device 20 and cancellation of the peripheral device 20 in use. At this time, the peripheral device management unit 120 sets a unique IP address and a unique connection port for the peripheral device 20 connected through the server communication unit 110. The peripheral device management unit 120 provides all state changing events of the peripheral device 20 to the peripheral device detection unit 140.

The peripheral device management unit 120 periodically requests the server communication unit 110 to transmit the connection information for connecting the peripheral device 20. That is, the peripheral device management unit verifies a connection state of the peripheral device 20 by periodically transmitting the connection information in order to reflect changed statuses of the peripheral device 20 and manages the list of the peripheral devices. For this, the peripheral device management unit 120 includes a peripheral device information storage module 125 that stores the profile information of the plurality of peripheral devices and the create list of the peripheral devices. That is, the peripheral device storage module 125 stores the peripheral device profile information including the device information, the driver information, the resource information, etc. Herein, the peripheral device storage module 125 stores the device information including the peripheral device description, the peripheral device ID, the vendor ID, the peripheral device type, the peripheral device usage, the peripheral device resolution, the connection interface, the button type, the color, the key number, etc. The peripheral device storage module 125 stores the driver information including the driver description, the driver publisher, the driver publisher URL, the driver date, the driver version, etc. The peripheral device storage module 125 stores the resource information including the resource type, the resource source, the resource authority, etc. The peripheral device information storage module 125 stores the list of the peripheral devices created in the peripheral device management unit 120 by using the peripheral device profile information on the plurality of peripheral devices 20. The peripheral device information storage module 125 also stores the list of the peripheral devices related to addition of a new peripheral device 20 and cancellation of the peripheral device 20 in use.

The user management unit 130 manages user information on the user terminal 200. That is, the user management unit 130 creates and manages the user information on the basis of the user profile information received from he user terminal 200 connected through the server communication unit 110. Herein, the user profile information managed by the user management unit 130 is XML-type data and the user profile information including personal information and preference of a user who uses the user terminal 200 is stored as the user information. Herein, the personal information, as personal information of the user who uses the user terminal 200, includes an ID, a name, a password, sex, age, an occupation, martial status, a location, schedule information, etc. The preference includes information on virtual systems (for example, virtual machine 30 and peripheral device 20) generally used by the user.

The user management unit 130 manages a user of the SoD virtual-machine offering system (that is, the user of the user terminal 200). The user management unit 130 receives a user registration message and the user profile information from the server communication unit 110 and manages the information when detecting the user. The user management unit 130 provides an event created by registration and cancellation of the user and information events of the virtual machine 30 and the peripheral device allocated to the user to the peripheral device detection unit 140.

The user management unit 130 further includes a user information storage module 135 that stores the user information. At this time, the user information storage module 135 stores the user information including a usage history and a usage pattern of the virtual machine 30 of the corresponding user and a preference of the corresponding user. That is, the user information storage module 135 stores the user's personal information including the ID, password, sex, age, occupation, martial status, location, schedule information, etc. and the preference including the information on the virtual system (for example, the virtual machine 30 and the peripheral device 20) generally used by the user.

The peripheral device detection unit 140 detects one or more peripheral devices 20 among the plurality of peripheral devices 20 managed by the peripheral device management unit 120 on the basis of the user profile information and the peripheral device profile information that are received from the user terminal 200 connected through the server communication unit 110. Herein, the peripheral device detection unit 140 detects one or more peripheral devices 20 among the plurality of peripheral devices 20 connected through the server communication unit 110 on the basis of the user information including the usage history and the usage pattern of the virtual machine 30 of the corresponding user. That is, the peripheral device detection unit 140 serves to detect the peripheral devices 20 to be used as the IO devices of the virtual machine 30 by receiving an event from each of the peripheral device management unit 120, the user management unit 130, and the virtual machine management unit 160. The peripheral device detection unit 140 detects the peripheral devices 20 to be used as the IO devices of the virtual machine 30 on the basis of the computing usage history information, virtual machine usage pattern, and preference information of the user at the time of detecting the peripheral devices 20 to be used as the IO devices.

The server control unit 150 allocates one of the plurality of created virtual machines 30 as the virtual machine 30 of the corresponding user terminal 200 when the server control unit 150 is connected to the user terminal 200 through the server communication unit 110. That is, the server control unit 150 creates the plurality of virtual machine 30 in advance before the server control unit 150 is connected to the user terminal 200 and provides the information on the plurality of virtual machines 30 to the virtual machine management unit 160. At this time, in the case of the plurality of virtual machines 30 created by the server control unit 150, the IO devices are not set. The server control unit 150 allocates one of the plurality of pre-created virtual machines 30 as the virtual machine 30 of the corresponding user terminal 200 when the server control unit 150 is connected to the user terminal 200 through the server communication unit 110.

The server control unit 150 sets one or more peripheral devices 20 detected by the peripheral device detection unit 140 as the IO devices of the virtual machine 30 allocated to the user terminal 200 that is connected the server control unit 150. That is, the server control unit 150 sets one or more peripheral devices 20 detected by the peripheral device detection unit 140 on the basis of the user profile information and the peripheral device profile information from the user terminal 200 as the IO devices of the virtual machine 30 allocated to the user terminal 200. At this time, the server control unit 150 may set at least one peripheral device 20 selected by the user terminal 200 among the plurality of peripheral devices 20 as the IO devices of the virtual machine 30 allocated to the corresponding user terminal 200. That is, the peripheral device detection unit 140 cannot detect the peripheral devices 20 to be used as the IO devices of the virtual machine 30 when there is no usage history of the SoD virtual-machine offering system of the connected user terminal 200. In this case, the server control unit 150 requests the user terminal 200 to input the peripheral devices 20 to be used as the IO devices of the virtual machine 30 and sets one or more peripheral devices 20 selected by the user terminal 200 as the IO devices of the virtual machine 30.

The virtual machine management unit 160 serves to manage information and a life cycle of the virtual machine 30 and performs a function on a request of the peripheral device detection unit 140. Further, the virtual machine management unit 160 transfers a life cycle changing event of the virtual machine 30 to the peripheral device detection unit 140.

The virtual kernel unit 170 provides a basic function in which the plurality of virtual machines 30 are configure and operated in the SoD virtual-machine offering system. For this, the virtual kernel unit 170 performs a kernel function by connecting virtual resources such as a virtual central processing unit, a virtual memory, virtual IO devices, etc and supporting various operating systems to operate the connected virtual resources as the virtual machine 30 and a function to reconfigure the resources of the virtual machine 30.

The server peripheral device driving unit 180, as a driver for driving the peripheral devices 20, drives the peripheral devices 20 that are set as the IO devices of the allocated virtual machine 30 in the user terminal 200. At this time, the server peripheral device driving unit 180 actuates one peripheral device 20 together with a terminal peripheral device driving unit 250 of the user terminal 200. The server peripheral device driving unit 180 manages connection to the peripheral device 20, connects the virtual machine 30 to the peripheral device 20, and controls an input/output (I/O) work. The peripheral device driving units are distributively positioned in the main server 100 and the user terminal 200, respectively. The server peripheral device driving unit 180 is positioned in the main server 100 and the terminal peripheral device driving unit 250 is positioned in the user terminal 200. The server peripheral device driving unit 180 is a driver for driving the peripheral devices 20. Each of the server peripheral device driving unit 180 and the terminal peripheral device driving unit 250 operate one peripheral device 20 and forms a distribution driver type.

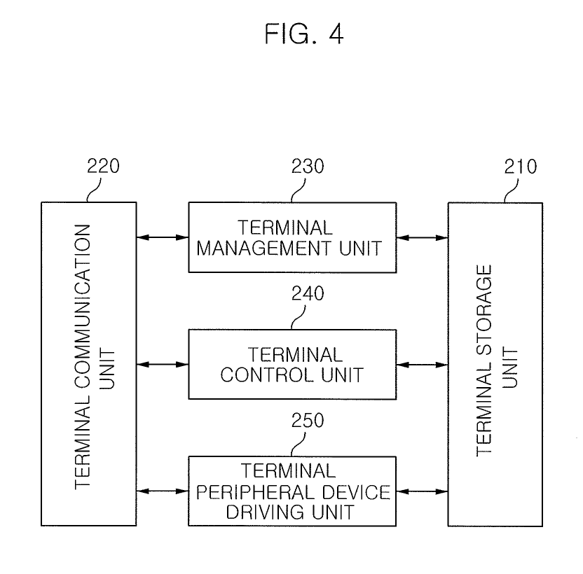

FIG. 4 is a diagram for illustrating a user terminal of FIG. 2.

As shown in FIG. 4, the user terminal 200 includes a terminal storage unit 210, a terminal communication unit 220, a terminal management unit 230, a terminal control unit 240, and a terminal peripheral device driving unit 250.

The terminal storage unit 210 stores the user profile information on the user of the user terminal 200. That is, the terminal storage unit 210 stores the user profile information including the personal information (Personal_Information) and the preference information (Preference_Information). Herein, the personal information, as personal information of the user who uses the user terminal 200, includes an ID, a name, a password, sex, age, an occupation, marital status, a location, schedule information, etc. The preference includes information on virtual systems (for example, virtual machine 30 and peripheral device 20) generally used by the user.

The terminal communication unit 220 transmits and receives data to and from the peripheral devices 20 around the user terminal 200 and the main server 100. That is, the terminal communication unit 220 receives for connection information for connecting the peripheral devices 20 from the main server 100 and provides the connection information to the terminal control unit 240. The terminal communication unit 220 transmits the peripheral device profile information and the user profile information to the main server 100 on a request of the terminal control unit 240. At this time, the terminal communication unit 220 may transmit the connection information for connecting the peripheral devices 20 around the user terminal 200 on a request of the terminal management unit 230.

The terminal management unit 230 manages the peripheral device profile information on one or more peripheral devices 20 connected through the terminal communication unit 220. That is, the terminal management unit 230 stores and manages the peripheral device profile information received from the peripheral devices 20 positioned around the user terminal 200. Of course, the terminal management unit 230 may manage the peripheral device profile information on the devices which can be used as the IO devices in the user terminal 200. At this time, the terminal management unit 230 periodically requests the terminal communication unit 220 to transmit the connection information in order to maintain the peripheral device profile information in a latest state.

The terminal control unit 240 requests transmitting the user profile information and the peripheral device profile information to the main server 100 when the terminal control unit 240 is connected to the main server 100 through the terminal communication unit 220. That is, the terminal control unit 240 requests the terminal communication unit 220 to transmit the use profile information stored in the terminal storage unit 210 and the peripheral device profile information stored in the terminal management unit 230 to the main server 100 when receiving the connection information from the main server 100 through the terminal communication unit 220.

The terminal peripheral device driving unit 250, as a driver for driving the peripheral devices 20, drives the peripheral devices 20 that are set as the IC devices of the virtual machine 30 allocated to the user terminal 200 in the main server 100. At this time, the terminal peripheral device driving unit 250 actuates one peripheral device 20 together with the server peripheral device driving unit 180 of the main server 100. The terminal peripheral device driving unit 250 manages connection to the peripheral device 20, connects the virtual machine 30 to the peripheral device 20, and controls the input/output (I/O) work.

(System on Demand Virtual-Machine Offering Method)

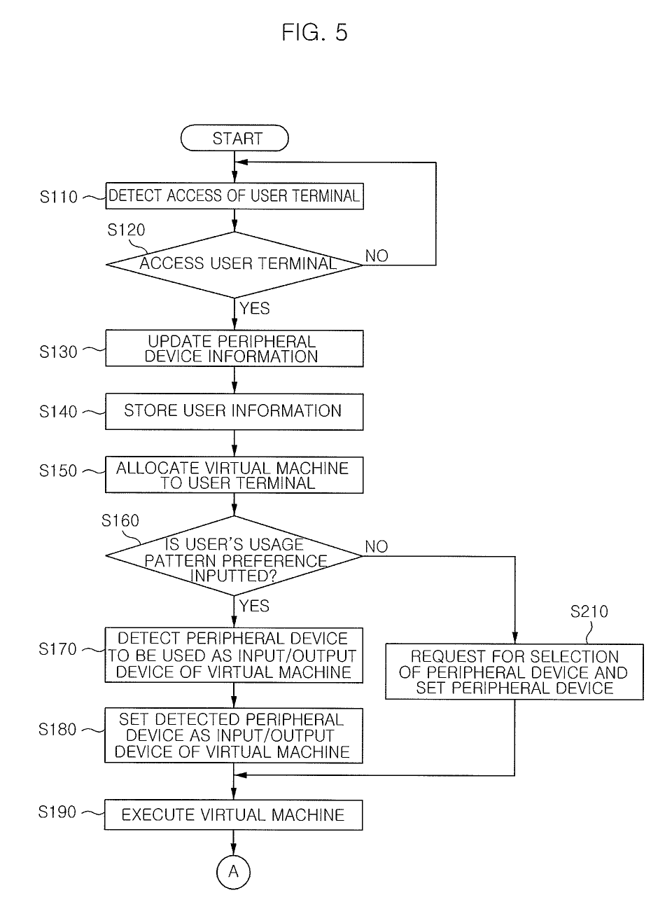

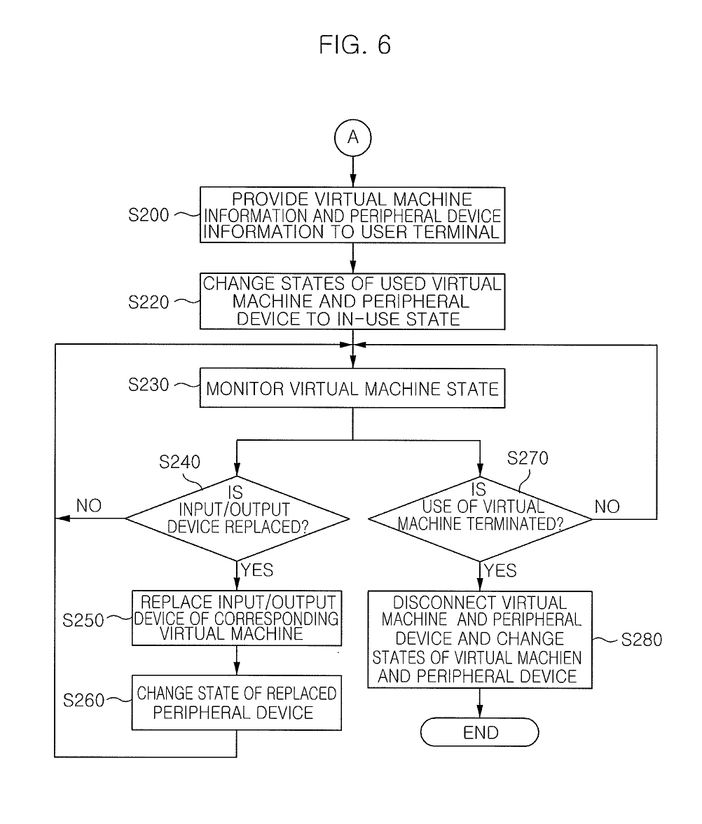

FIGS. 5 and 6 are flowcharts for illustrating a method for offering a SoD virtual-machine according to an embodiment of the present invention.

First, peripheral devices 20 positioned around a main server 100 are registered in the main server 100 before a virtual machine 30 is allocated to a user. That is, the main server 100 stores peripheral device information (i.e., peripheral device profile information, a list of peripheral devices, etc.) on peripheral devices 20 positioned in an area to which the SoD virtual machine is offered. Herein, a content in which the main server 100 stores the peripheral device information (i.e., the peripheral device profile information, the list of peripheral devices, etc.) on the peripheral devices 20 will be described below.

Further, the user should possess a user terminal 200 (i.e., a mobile phone, a PDA, a USB, etc.) and the user terminal 200 includes user profile information (that is, authentication information) for user authentication. That is, the user possesses the user terminal 200 that stores the user profile information including user's personal information and preference. At this time, the main server 100 registers user terminals 200 that do not include the user profile information as the peripheral devices 20.

As an SoD virtual-machine offering system is actuated, a peripheral device management unit 120 of the main server 100 periodically transmits connection information through a server communication unit 110 to detect the user terminal 200 (S110). The server communication unit 110 transmits the connection information to a plurality of predetermined peripheral devices 20 and the user terminal 200 on a request of the peripheral device management unit 120. At this time, the server communication unit 110 preferably transmits the connection information to the plurality of predetermined peripheral devices 20 and the user terminal 200 that are positioned in an area to which the SoD virtual-machine 30 can be offered. When the user terminal 200 receives the connection information from the main server 100 through a terminal communication unit 220, a terminal control unit 240 receives the peripheral device profile information from a terminal peripheral device driving unit 250 and transmits the peripheral device profile information to the peripheral device management unit 120 of the main server 100 by using the terminal communication unit 220. The terminal control unit 240 checks whether or not the user profile information is provided in the user terminal 200 and transmits the user profile information to the user management unit 130 by using the terminal communication unit 220. A server control unit 140 determines connection of the user terminal 200 when receiving the user profile information and the peripheral device profile information in response to the connection information through the server communication unit 110.

When the user terminal 200 is connected through the server communication unit 110 (S120; YES), the peripheral device management unit 120 updates peripheral device information on the basis of the peripheral device profile information received through the server communication unit 110 (S130). A peripheral device information storage module 125 stores the peripheral device profile information received through the server communication unit 110, and adds a list of the peripheral devices created by the peripheral device management unit 120 to a pre-stored list of peripheral devices and updates the lists. That is, when the user terminal 200 includes three peripheral devices 20 (that is, a keyboard, a video player, and a monitor), the peripheral device management unit 120 registers three peripheral devices 20.

In addition, a user management unit 130 creates user information on the basis of the user profile information received through the server communication unit 110 and stores the created user information in a user information storage module 135 (S140). That is, the user management unit 130 stores the personal information and preference included in the user profile information received from the user terminal 200 and a virtual machine usage history and a usage pattern of the corresponding user in the user information storage module 135 as the user information. At this time, the user management unit 130 may store the user profile information received through the server communication unit 110 in the user information storage module 135. The user management unit 130 analyzes the user profile information received from the user terminal 200 and determines the characteristic of the registered user and requests creation of the virtual machine 30 to be allocated to the corresponding user by creating a user registration event.

The server control unit 150 sets a virtual machine 30 to be allocated to the user terminal 200 among a plurality of pre-created virtual machines 30 by using the user information stored in the user information storage module 135 and the peripheral device information stored in the peripheral device information storage module 125 when receiving the user registration event from the user management unit 130 (S150). At this time, the server control unit 150 allocates a virtual machine 30 suitable for the corresponding user by using the type of the virtual machine 30 which can be currently used and information thereon, and information of the user's usage pattern of the virtual machine, the preference, etc that are included in the user information.

When the virtual machine usage pattern information, preference, etc. of the corresponding user are inputted (S160; YES), the server control unit 150 requests a peripheral device detection unit 140 to detect peripheral devices 20 to be used as IO devices of the virtual machine 30 allocated to the user terminal 200 (S170). Therefore, the peripheral device detection unit 140 detects peripheral devices 20 suitable for the corresponding user by using the user information from the user management unit 130 and the peripheral device information from the peripheral device management unit 120. That is, the peripheral device detection unit 140 requests the user information to the user management unit 130 and the peripheral device information to the peripheral device management unit 120. The user management unit 130 detects the corresponding user information from the user information storage module 135 on a request of the peripheral device detection unit 140 and provides the detected user information to the peripheral device detection unit 140. The peripheral device management unit 120 detects the corresponding peripheral device information from the peripheral device information storage module 125 on the request of the peripheral device detection unit 140 and provides the detected peripheral device information to the peripheral device detection unit 140. The peripheral device detection unit 140 detects one or more peripheral devices 20 suitable for the user by analyzing past virtual machine usage pattern information of the currently registered user and provides the detected peripheral devices 20 to the server control unit 150.

The server control unit 150 sets the peripheral devices 20 received from the peripheral device detection unit 140 as the IO devices of the pre-allocated virtual machine 30 (S180). That is, the server control unit 150 sets one or more peripheral devices 20 received from the peripheral device detection unit 140 as the IO devices of the virtual machine 30 allocated at step S150. The server control unit 150 requests a virtual machine management unit 160 to execute the virtual machine when the virtual machine 30 and the IO devices are set.

The virtual machine management unit 160 executes the corresponding virtual machine 30 on a request of the server control unit 150 (S190). The virtual machine management unit 160 executes the virtual machine 30 set in the server control unit 150. The virtual machine management unit 160 provides peripheral device information (that is, an IP address, a port number for monitor connection, etc.) on one or more peripheral devices 20 set as the IO devices to a server peripheral device driving unit 180.

Therefore, the server peripheral device driving unit 180 transfers information of the virtual machine 30 related to the virtual machine 30, the peripheral device information, etc. to a terminal peripheral device driving unit 250 (S200). At this time, the server peripheral device driving unit 180 transfers the IP address, the port number, etc. of the corresponding peripheral device 20 to the terminal peripheral device driving unit 250. The terminal peripheral device driving unit 250 connects a monitor by means of the corresponding IP address and port number. Thereafter, a driving screen of the virtual machine 30 is displayed on the monitor and waits input information through selection of a keyboard and a mouse.

At this time, when the usage pattern information of the virtual machine, the preference, etc. are not inputted, the server control unit 150 requests the user to select peripheral devices 20 to be used as the IC devices of the virtual machine 30 (S210). The user manipulates and sets the peripheral devices to be used as the IC devices while the user sees the screen of the virtual machine 30 outputted onto the monitor. At this time, the corresponding peripheral device 20 is allocated to the current virtual machine 30 by pressing any keyboard and the corresponding mouse is allocated by dragging a desired mouse.

The virtual machine 30 is configured by such a method and the user performs his/her desired work by using the virtual machine 30. Thereafter, the user terminal 200 transmits a usage time, input/output device selection information, application program usage information, etc. of the virtual machine 30 as the user pattern information to the virtual machine management unit 160. The virtual machine management unit 160 stores data received from the user terminal 200 and the data are reused as input materials of the peripheral device detection unit 140. If a new user is registered, a new virtual machine 30 is configured such a method and only the peripheral devices 20 other than the peripheral device 20 in use are allocated.

Next, the server control unit 150 controls the virtual machine management unit 160 and the peripheral device management unit 120 so as to change states of the virtual machine 30 and the peripheral devices 20 allocated to the user terminal 200 (S220). That is, the virtual machine management unit 160 changes the state of the virtual machine 30 to an in-use state so as to prevent other users from using the virtual machine 30 offered to the user. The peripheral device management unit 120 changes the peripheral devices 20 used as the IO devices of the virtual machine 30 to the in-use state so as to prevent other users from using the peripheral devices 20.

The server control unit 150 controls the virtual machine management unit 160 and the peripheral device management unit 120 so as to periodically monitor the state of the virtual machine 30 (S230). At this time, when a request signal for replacing the IO device (KVM) is received from the user terminal 200 (S240; YES), the server control unit 150 replaces the IO devices of the corresponding virtual machine 30 by using the peripheral device information requested from the user terminal 200 (S250).

When the IO devices (that is, the peripheral devices 20 set as the IO devices of the virtual machine 30) are replaced, the server control unit 150 controls the peripheral device management unit 120 so as to change the states of the corresponding peripheral devices 20 (S260). Therefore, the peripheral device management unit 120 changes the peripheral devices 20 before replacement to a usage cancellation state and changes the replaced peripheral devices 20 to the in-use state. The peripheral device management unit 120 updates the peripheral device information stored in the peripheral device information storage module 125.

When the user terminates the usage of the virtual machine 30 (S270; YES), the server control unit 150 disconnects the virtual machine 30 and the peripheral devices 20 allocated to the user terminal 200 and controls the virtual machine management unit 160 and the peripheral device management unit 120 so as to change the states of the disconnected virtual machine 30 and the peripheral devices 20 (S280). Therefore, the virtual machine management unit 160 disconnects the virtual machine offered to the user and changes the corresponding virtual machine 30 to the usage cancellation state. The peripheral device management unit 120 changes the corresponding peripheral devices 20 to the usage cancellation state and updates the peripheral device information stored in the peripheral device information storage module 125.

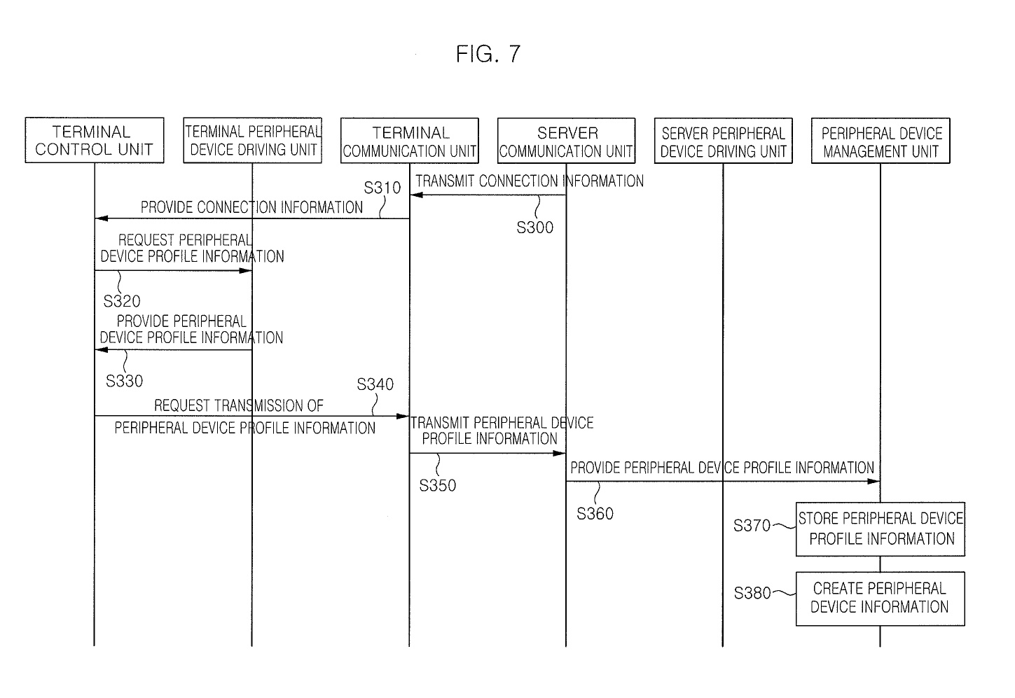

FIG. 7 is a flowchart for illustrating a method for registering peripheral devices 20 according to an embodiment of the present invention.

First, the server communication unit 110 periodically transmits the connection information on the request of the peripheral device management unit 120 (S300). That is, the peripheral device management unit 120 of the main server 100 requests the server communication unit 110 to periodically transmit the connection information in order to connect one or more peripheral devices 20 positioned around the peripheral device management unit 120. Therefore, the server communication unit 110 transmits the connection information to a plurality of predetermined peripheral devices 20. At this time, the server communication unit 110 preferably allows only peripheral devices 20 that are positioned in an area to which the SoD virtual-machine 30 can be offered to receive the connection information.

A terminal communication unit 220 receives the connection information from the server communication unit 110 and provides the received connection information to a terminal control unit 240 (S310).

Therefore, the terminal control unit 240 requests the peripheral device profile information to the terminal peripheral device driving unit 250 (S320). At this time, the terminal control unit 240 requests peripheral device profile information including device information, driver information, and resource information.

The terminal peripheral device driving unit 250 provides a profile of the peripheral device 20 to the terminal control unit 240 on a request of the terminal control unit 240 (S330).

The terminal control unit 240 requests the terminal communication unit 220 to transmit the peripheral device profile information provided from the terminal peripheral device driving unit 250 (S340).

The terminal communication unit 220 transmits the peripheral device profile information to the main server 100 on the request of the terminal control unit 240 (S350) and the server communication unit 110 of the main server 100 receives the peripheral device profile information from the peripheral devices 20 and provides the received peripheral device profile information to the peripheral device management unit 120 (S360).

The peripheral device management unit 120 stores the received peripheral device profile information in the peripheral device information storage module 125 (S370).

The peripheral device management unit 120 creates peripheral device information by using the stored peripheral device profile information (S380). That is, the peripheral device management unit 120 updates and manages a list of peripheral devices 20 which can be connected to the main server 100.

As described above, a system and a method for offering a SoD virtual-machine can construct a computing environment suitable for a circumference status around a user by offering a virtual machine 30 using a plurality of peripheral apparatuses 20 positioned around the user and a computing peripheral device as resources.

Further, the system and method for offering a system on demand virtual-machine can provide various input/output services by using formalized devices allocated to the virtual machine 30 and a plurality of peripheral devices 20 around the user as input/output devices.

That is, in the system and method for offering a system on demand virtual-machine, the user can arbitrarily use all ubiquitous computing peripheral devices 20 distributed around the user in a virtual system environment, dynamically add a new peripheral device 20, and dynamically manage the virtual system environment.

Although preferred embodiments of the present invention have been described, it will be appreciated by those skilled in the art that various modifications and changes may be made without departing from the appended claims of the present invention.

What is claimed is:

1. A system for offering a system on demand (SoD) virtual-machine including a main server, wherein the main server includes:
a server communication unit that transmits and receives data to and from a plurality of peripheral devices and a plurality of user terminals;
a peripheral device detection unit that detects one or more peripheral devices among peripheral devices around the user terminal on the basis of user information received from the user terminal connected through the server communication unit and peripheral device information around the connected user terminal; and
a server control unit that sets one or more peripheral devices detected by the peripheral device detection unit as IO devices of a virtual machine allocated to the user terminal.

2. The system for offering an SoD virtual-machine according to claim 1, wherein the peripheral device detection unit detects one or more peripheral devices among the plurality of peripheral devices which can be connected through the server communication unit on the basis of user information including a usage history and a usage pattern of the virtual machine of the corresponding user.

3. The system for offering an SoD virtual-machine according to claim 1, wherein the server control unit sets peripheral devices selected by the user terminal among one or more peripheral devices detected by the peripheral device detection unit as the IO devices of the virtual machine allocated to the corresponding user terminal.

4. The system for offering an SoD virtual-machine according to claim 1, further comprising:
a peripheral device management unit that creates and manages a list of peripheral devices on the basis of profile information received from the plurality of peripheral devices connected through the server communication unit.

5. The system for offering an SoD virtual-machine according to claim 4, wherein the peripheral device management unit includes a peripheral device information storage module that stores the profile information of the plurality of peripheral devices and the list of the peripheral devices.

6. The system for offering an SoD virtual-machine according to claim 4, wherein the peripheral device management unit sets a unique IP address and a unique connection port to the peripheral device connected through the server communication unit.

7. The system for offering an SoD virtual-machine according to claim 4, wherein the peripheral device management unit creates connection information for connecting the peripheral devices through the server communication unit.

8. The system for offering an SoD virtual-machine according to claim 1, further comprising:
a user management unit that creates and manages the user information on the basis of user profile information received from the user terminal connected through the server communication unit.

9. The system for offering an SoD virtual-machine according to claim 8, wherein the user management unit further includes a user information storage module that stores the user information and the user profile information, and
wherein the user information storage module stores the user information including the usage history and the usage pattern of the virtual machine of the corresponding user and a preference.

10. A user terminal that can exchange information with a mains server of a system for offering a system on demand (SoD) virtual-machine, comprising:
a terminal storage unit that stores user profile information on a user of the user terminal;
a terminal communication unit that transmits and receives data to and from the main server;
a terminal management unit that manages peripheral device profile information on one or more peripheral devices around the user terminal connected through the terminal communication unit; and
a terminal control unit that transmits the peripheral device profile information and the user profile information to the main server.

11. The user terminal according to claim 10, wherein the terminal management unit creates connection information for connecting peripheral devices around the user terminal through the terminal communication unit.

12. A method for offering a system on demand (SoD) virtual-machine, comprising:
allocating a virtual machine to a user terminal by a server control unit;
receiving user profile information and profile information of peripheral devices around the user terminal from the user terminal by a server communication unit;
detecting one or more peripheral devices, by a peripheral device detection unit, among a plurality of peripheral devices around the user terminal which can be connected through the server communication unit on the basis of the user profile information and the profile information of the peripheral devices around the user terminal; and
setting detected one or more peripheral devices as IO devices of the allocated virtual machine by the server control unit.

13. The method for offering an SoD virtual-machine according to claim 12, wherein at detecting one or more peripheral devices, one or more peripheral devices are detected among the plurality of peripheral devices on the basis of a usage history and a usage pattern of the virtual machine of the corresponding user by the peripheral device detection unit.

14. The method for offering an SoD virtual-machine according to claim 12, wherein at setting one or more peripheral devices detected by the server control unit as IO devices of the virtual machine, peripheral devices selected by the user terminal among detected one or more peripheral devices are set as IO devices of the allocated virtual machine by the server control unit.

15. The method for offering an SoD virtual-machine according to claim 12, further comprising:
creating and managing a list of peripheral devices on the basis of the profile information received from the plurality of peripheral devices by a peripheral device management unit.

16. The method for offering an SoD virtual-machine according to claim 15, wherein at creating and managing the list of peripheral devices, a unique IP address and a unique connection port are set to the peripheral devices connected through the server communication unit by the peripheral device management unit.

17. The method for offering an SoD virtual-machine according to claim 15, wherein at creating and managing the list of peripheral devices, connection information for connecting the peripheral devices is created through the server communication unit by the peripheral device management unit.

18. The method for offering an SoD virtual-machine according to claim 15, wherein at creating and managing the list of peripheral devices, the information on the plurality of peripheral devices and the list of the peripheral devices are stored in a peripheral device information storage module by the peripheral device management unit.

19. The method for offering an SoD virtual-machine according to claim 12, further comprising:
creating and managing user information on the basis of the user profile information received from the user terminal by a user management unit.

20. The method for offering an SoD virtual-machine according to claim 12, wherein at receiving user profile information and profile information of peripheral devices, the peripheral device profile information on one or more peripheral devices connected to the user terminal and the user profile information of the connected user terminal are received by the server communication unit.
